(19) United States
(12) Patent Application Publication
(10) Pub. No.: US 2010/0188246 A1
(43) Pub. Date: Jul. 29, 2010

(54) INORGANIC THICK FILM AC ELECTROLUMINESCENCE ELEMENT HAVING AT LEAST TWO INPUTS, AND PRODUCTION METHOD AND USE

(75) Inventors: Martin Philipp Getrost, Sankt Augustin (DE); Michael Heite, Olpe (DE); Thomas Wagner, Hasselroth (DE); Thilo-J Werners, Leverkusen (DE)

Correspondence Address: CONNOLLY BOVE LODGE & HUTZ, LLP, P O BOX 2207, WILMINGTON, DE, 19899, US

(73) Assignee: BAYER MATERIALSCIENCE AG, Leverkusen (DE)

(21) Appl. No.: 12/666,071

(22) PCT Filed: Jun. 27, 2008
(86) PCT No.: PCT/EP2008/058279

§ 371 Date: Dec. 22, 2009

(30) Foreign Application Priority Data
Jun. 28, 2007 (DE) 10 2007 030 108.3

(51) Int. Cl. H05B 33/08; H05B 33/28; G08B 5/36; B64D 47/02; H05B 33/10

(52) U.S. Cl. 340/815.4; 313/503; 362/470; 315/174; 445/23

(57) ABSTRACT

The invention relates to an electroluminescence (EL) element based on a particular zinc sulfide thick film with at least two planar electrodes, wherein at least one planar electrode is designed to be transparent. At least two AC voltage inputs are provided on each electrode at two points which are spaced apart. Moreover, the invention relates to methods for the production of the electroluminescence element and to the use thereof.

The present invention relates to an electroluminescent element based on zinc sulfide electroluminophore thick films, a method for the production of an electroluminescent element according to the invention, and the use of an electroluminescent element according to the invention as a decorative element and/or luminous element in interiors or for external use, preferably on external facades of buildings, in or on facilities/installations, in or on land, airborne or waterborne vehicles, in or on electrical or electronic devices or equipment, or in the advertising sector.

Electroluminescence (hereinafter also abbreviated to “EL”) is understood to mean the direct excitation of luminescence from luminescent pigments (also termed luminescent substances, luminophores or electroluminescent, EL or luminescent phosphors) by an alternating electric field.

Electroluminescence technology has recently become increasingly important. This technology enables homogeneous luminous surfaces free of dazzle and shadow and of virtually any desired size to be formed. At the same time the power consumption and structural thickness (of the order of magnitude of a millimetre or less) are extremely low. Typical uses include, apart from the background illumination of liquid crystal displays, the back-lighting of transparent films that are provided with lettering and/or image motifs. Thus, transparent electroluminescent arrangements, for example electroluminescent luminous boards based on glass or transparent plastics, which can serve for example as information carriers, advertising panels, or for decorative purposes, are known from the prior art.

A zinc sulfide electroluminescent arrangement based on the use of two electrodes of conducting glass with an electroluminescent phosphor arranged therebetween was already described in 1950 by E. C. Payne in U.S. Pat. No. 2,838,715, and a publication by G. Destriau “The New Phenomenon of Electroluminescence and its Possibilities for the Investigation of Crystal Lattice” in the “Philosophical Magazine” was mentioned by way of reference, in which connection the original discovery of the particular ZnS EL phenomenon in an alternating voltage field was already made by Destriau in 1936.

The luminescent pigments that are used in these EL elements are embedded in a transparent, organic or ceramic binder. The starting substances are generally zinc sulfides, which depending on doping or co-doping and preparation procedure generate different, relatively narrow-band emission spectra. The reason for the use of zinc sulfides in the EL layers is due on the one hand to the relatively large number of types of zinc sulfide EL pigments that are available. The centre of gravity of the spectrum at the same time determines the respective colour of the emitted light. The emission colour of an EL element can be matched by means of a large number of possible measures to the desired colour impression. These measures includes the doping and co-doping of the luminescent pigments, the mixing of two or more EL pigments, the addition of one or more organic and/or inorganic colour-converting and/or colour-filtering pigments, the coating of the EL pigment with organic and/or inorganic colour-converting and/or colour-filtering substances, the admixture of colorants to the polymer matrix in which the luminescent pigments are dispersed, as well as the incorporation of a colour-converting and/or colour-filtering layer or film in the structure of the EL element. In general, depending on the employed doping and co-doping of the zinc sulfide pigments a relatively broad-band emission spectrum is produced if a suitably high alternating voltage of typically greater than 50 volts up to more than 200 volts and a frequency of greater than 50 Hz up to a few kHz, normally in the range from 400 Hz to 2 kHz, is applied.

In order that the produced emission can be seen, at least one flat (planar) electrode is preferably designed to be largely transparent.

Depending on the application and production technology, glass substrates or polymeric films with an electrically conducting and largely transparent coating can be used for this purpose. In special embodiments an EL capacitor structure can also be arranged on a substrate in such a way that as front transparent electrode only a thin layer is printed or knife coated or is applied by a roller coating method or a curtain casting method or a spray method. In principle both flat electrodes can also be made largely transparent and in this way a translucent EL element is formed that exhibits a light emission on both sides.

A transparent electrode is understood in the context of the present invention to denote an electrode that is made of a material that has a transmission in the visible wavelength region of in general more than 60%, preferably more than 70%, particularly preferably more than 80% and most particularly preferably more than 90%.

The flat electrically conducting and largely transparent electrodes can be Inorganic in nature and can be produced by means of vacuum technology, chemically, galvanically or by firing/stoving techniques. In general the thin layers are based on ITO (indium tin oxides) or are based on thin metallic or metal oxide layers. These generally have sheet resistance values of a few Ω/square up to several 100 Ω/square. Normal values are 5 to 60 Ω/square. They can also be used for large areas, in which case the thickness layers are normally in the sub-micrometre range.

The flat electrically conducting and largely transparent electrodes can however also be formed on the basis of an inorganic binder matrix. In this case they are generally applied by printing techniques, for example screen printing, or over large areas by means of knife coating methods, roller coating methods, curtain casting methods or spray methods and the like.

In conventional EL capacitor structures a rear electrode that is highly conducting generally in the range of mΩ/square is connected at one site to the alternating voltage source, and the in general less highly conducting transparent other electrode is generally provided at the edges with a current connection (hereinafter this current connection is termed a “busbar”). The second alternating voltage contact is applied to this busbar. In addition it is also possible to provide the employed rear electrode with a busbar.

The electroluminescent elements known from the prior art have still not been completely developed and refined as regards their functions. Thus, for example, up to now no electroluminescent elements are known from the prior art that exhibit a change in brightness in combination with a visually detectable beat effect. This is important for electroluminescent elements with which for example striking optical effects are to be achieved.

Accordingly an object of the present invention is to provide an electroluminescent element which exhibits a change in brightness in combination with a visually detectable beat effect.

A beat denotes in this connection the result obtained by the additive superposition of two vibrations that differ only slightly from one another as regards their frequency. Beats occur in all waves in which the principle of superposition applies, and thus also in electromagnetic waves. In brief, a beat is a vibration of periodically changing amplitude, and is obtained by the superposition of vibrations with similar frequencies. The amplitude varies with the so-called beat frequency, which corresponds to the difference of the frequencies of the two vibrations.

This object is achieved by an electroluminescent element based on a particular zinc zulfide thick film with at least two flat (planar) electrodes, in which at least one flat electrode is designed to be transparent.

The electroluminescent element according to the invention is then characterised in that on at least one electrode at least two alternating voltage feeders are provided on two sites spaced apart from one another.

When in the context of the present invention an electroluminescent element is used with at least two alternating voltage feeders at least on one electrode, and different voltages and frequencies are applied to the respective alternating voltage feeders, electroluminescence emissions are generated that produce a brightness behaviour or a change in brightness of the electroluminescent element corresponding to the difference or the change of the at least two alternating voltage feeders. Furthermore, in addition or also exclusively different frequencies can be applied, whereby in addition or exclusively beat effects are generated.

According to the invention at least two feeders per electrode are thus provided on at least one electrode of the electroluminescent element according to the invention. By applying different voltages and/or different frequencies the desired change in brightness and/or visually detectable beat effects can be generated.

In this connection the expression “spaced apart from one another” is understood in the context of the present invention to mean that the individual alternating voltage feeders are not directly in contact with one another. The size of the interspacing is variable and depends on the desired visual effect to be achieved.

Preferred embodiments of the present invention are now described hereinafter.

In general the electrode surfaces are provided with busbars, via which the alternating voltages can be applied. The arrangement of these busbars in relation to the flat electrodes can vary and depends on the effect to be optically achieved, since the visual effects take place between the individual alternating voltage feeders, i.e. in the region between the individual busbars. Moreover, a plurality of alternating voltage feeders, such as for example 2, 3, 4, 5, 6, 7, 8, 9, 10, 11, 12, 13, 14 or 15 or n alternating voltage feeders can be provided on a flat electrode of the electroluminescent element according to the invention. Furthermore, it is also possible to provide even more alternating voltage feeders on one of the flat electrodes of the electroluminescent element according to the invention. In addition, the electroluminescent element according to the invention can also include more flat electrodes, such as for example 2, 3, 4, 5, 6, 7, 8, 9, 10, 11, 12, 13, 14 or 15 or n electrodes. In this case each flat electrode can in turn be provided with a plurality of alternating voltage feeders.

The individual busbars that are used can vary as regards their shape and size and can for example be formed as strips of arbitrary width and length, but can also be punctiform or of circular shape. Depending on the employed materials, it is a simple matter for the person skilled in the art to select suitable sizes and shapes of the busbars depending on the desired visual effects.

In a first embodiment a rectangular EL element for example is designed in such a way that the transparent electrode surfaces on two oppositely facing edges are provided with a busbar and these busbars are in turn provided with connection contacts for the alternating voltage feeders.

The corresponding busbars can in a preferred configuration of the electroluminescent element according to the invention be formed by highly conducting printable pastes. These pastes may for example be opaque silver pastes, copper pastes, tin pastes, zinc pastes, palladium pastes, aluminium pastes, carbon pastes or mixtures of these pastes. Suitable printing pastes are basically not subject to any restriction as regards the sheet resistance. Normally however they have a sheet resistance in the range from below 10 mΩ/square to a few 100 mΩ/square.

The busbar is preferably arranged outside the EL field and is preferably designed so that it can produce a uniform EL emission over the whole EL surface.

Especially in the case of large surface areas or interspacings and relatively high resistance transparent electrode layers, the use of busbars is advantageous for a uniform EL emission.

The electrically conducting contact strips that are formed for example as busbars by the printable pastes can in general be applied by means of screen printing, brush application, ink-jet, knife coating, roller, by spraying or by means of dispenser application or comparable application methods known to the person skilled in the art, to the electrically conducting and at least partially transparent thin coatings and then in general heat treated in an oven so that strips normally applied laterally along a substrate edge can be contacted in a good electrically conducting manner by means of soldering, clamping, crimping, riveting, bonding or a plug-in connection.

To operate this electroluminescent element according to the invention, in the simplest configuration all that is required is an EL inverter or an EL voltage supply. In this case one pole is connected to the rear electrode and the other pole is divided into two connections, and at least one connection or also both connections are connected to the respective busbars via a regulating unit, such as for example a potentiometer.

In this connection the interspacing of the respective busbars can be varied. The interspacing accordingly depends basically on the visual effects to be achieved, since the visual effects occur substantially in the region of the electroluminescent element according to the invention, which is located between the individual busbars and alternating voltage feeders.

By appropriately adjusting the regulating unit, i.e. for example the potentiometer, a timewise and/or spatial brightness behaviour and/or a timewise and/or spatial change in brightness can now be achieved in the EL region between the two alternating voltage feeders, i.e. between the busbars.

In principle only one potentiometer is required, and in this way a change in the EL brightness, i.e. a variable brightness behaviour, can be achieved on the corresponding side.

If two regulating units are used, for example two potentiometers, then if desired a change in brightness can be achieved on both sides.

Instead of the potentiometers electronic regulating circuits can obviously be used, which can be controlled as regards the timewise brightness behaviour by appropriate programming or by means of a sensor.

It is possible for the electroluminescent element according to the invention to comprise only one EL voltage source. In a further modification of the present invention two or more EL voltage sources, so-called EL inverters, i.e. electronic components that convert a direct voltage, for example a low value direct voltage to a for example higher alternating voltage, can however be used. In this connection so-called EL chip inverters can also be used with small EL fields. In particular EL chip inverters with a plurality of output poles can be used.

In this way the number of EL voltage sources can furthermore be adapted to the number of feeder points or feeder lines. In one modification of the present invention a flat electrode can be designed to be transparent in the meaning of the present invention.

In a further modification of the present invention also both flat electrodes of the electroluminescent element according to the invention, i.e. the front electrode as well as the rear electrode, can be designed transparent, so that a light emission can be achieved on both sides.

The second transparent electrode can for example be supplied conventionally from an EL voltage source or, like the front transparent electrode, can be designed with two or more EL voltage poles.

The shape of the electroluminescent element according to the invention and in particular the shape of the individual electrodes are not subject to any particular restriction. In addition to a rectangular shape, in this connection strip-shaped, triangular, polygonal, round, oval or virtually any other geometrical shapes can be used. It is also possible to configure the electroluminescent element in the form of a wire or a tube.

In all cases the sheet conductivity should however be adapted to the maximum voltage difference, since the voltage difference of the respective two voltage sources with the smallest interspacing is reflected as an ohmic loss over the surface. If the sheet conductivity is too high and there is a small interspacing and at the same time a high voltage difference, a corresponding dissipation or power loss will occur. This dissipation can lead to a heating of the electroluminescent element according to the invention, which can possibly lead to its destruction.

For example in the case of a square electrode surface with 60 ohm/square, if a voltage of for example 150 volts and 156 volts, i.e. a voltage difference of 6 volts, is applied, a current of 0.1 ampere will flow. In this case there is an electrical power loss of 0.6 Watt, which is normally radiated in the form of heat or has to be dissipated. In the case of a correspondingly large surface such a current load is no problem. In the case of a correspondingly small surface however such a current load can lead to a thermal overloading. The sheet resistance is therefore preferably adapted to the relevant conditions in each case. In other words, the size and the sheet resistance have to be matched so that the desired visual effect occurs.

In a further modification of the invention two EL voltages can be connected to the front electrode and two EL voltages to the rear electrode, and the voltage difference can be modulated according to a predetermined program or can be controlled by means of sensors, wherein in one embodiment the in each case two voltages are preferably switched at the top and bottom and on the right and left via busbars, i.e. are switched at a right angle to one another (this configuration is shown in FIG. 1 of the present invention). In addition it is however also possible for the two EL voltages on the front electrode and the two EL voltages on the rear electrode to be arranged in each case above one another by means of busbars, as is illustrated for example in FIG. 6 of the present invention.

Any other suitable arrangements are however possible independently of these configurations.

Instead of the in each case two EL voltages, one voltage supply with a branched second electronically regulated voltage can of course also be used.

In a further embodiment of the present invention, if at least two EL voltage sources are used then not only different voltages but also different frequencies can be employed. By using different frequencies beat effects can thereby be achieved, in which connection relatively low frequency differences are advantageous for a visually recognisable effect. The employed frequency differences can vary and depend on the desired visual effect, in which connection frequencies of less than 50 Hz are preferred since the visual effects can otherwise no longer be recognised.

If a plurality of EL voltage supplies are used on a plurality of the front electrodes and/or on a plurality of the rear electrodes, with a corresponding possibility of controlling the voltage and frequency, a very great variety of visual effects can be achieved. This plurality of visual effects can be increased still further if more than two flat electrodes, thus for example three, four or five flat electrodes, are used in the electroluminescent element according to the invention.

In addition it is possible to control and simulate the voltage level and the voltage difference, and the frequency and the frequency difference, by the loudness and the frequency response of a music source, so that a visual reproduction of the music source is possible.

Moreover, the electroluminescent element according to the invention can be used as a visual indicator for a large number of measurable and sensorially detectable quantities, such as for example noise, smoke, vibration, velocity, atmospheric humidity, temperature and similar quantities.

In a further modification of the present invention the electroluminescent field provided according to the invention can be implemented not only in a uniformly luminous manner, but can also have a punctiform, star-shaped, triangular, strip-shaped or virtually any other graphically choosable configuration and shape. In this connection the individual elements can be geometrically exact or positioned exactly, or can be randomly arranged. These different configurational possibilities are the result of the large number of different positions of the alternating voltage feeders.

In yet a further modification of the present invention the electroluminescent element according to the invention can be three-dimensionally shaped by a choice of suitable thermoformable films and layers and can optionally be sprayed on the back.

The three-dimensional forming of graphically shaped plastics films can be carried out with very short cycle times of a few seconds for example according to the prior art with the isostatic high-pressure forming process (HPFP), which is described in detail in EP 0 371 425 (process for the production of thermoformed plastics moulded parts).

In the embodiment in a glass element the EL region is preferably designed in such a way that an inspection port through the glass element in the sense of a window element remains. In this connection a central inspection region can be kept completely free of EL elements or the EL screen (grid) is designed with large interspacings in a for example centrally arranged inspection region. The EL element interspacings can in this connection be chosen to be progressively smaller in the direction of the margins.

The electroluminescent element according to the invention can in addition contain particles with nanostructures.

In the scope of the present invention the expression “particles with nanostructures” is understood to denote nano-scale material structures that are selected from the group consisting of single-wall carbon nanotubes (SWCNTs), multi-wall carbon nanotubes (MWCNTs), nanohorns, nanodisks, nanocones (i.e. structures with conically shaped jackets), metallic nanowires and combinations of the aforementioned particles. Corresponding particles with nanostructures based on carbon can for example consist of carbon nanotubes (single-wall and multi-wall), carbon nanofibres (herringbone, platelet-type, screw-type) and the like.

“Kohlhenstoffnanorohrchen” are internationally also termed carbon nanotubes (single-walled and multi-walled) and “Kohlenstoff-nanofasern” are also termed carbon nanofibres (herringbone, plate-let-type, screw-type).

With regard to metallic nanowires, reference is made to WO 2007/022226 A2, the disclosures of which regarding the nanowires disclosed therein are incorporated by way of reference in the present invention. The electrically highly conducting and largely transparent silver nanowires described in WO 2007/022226 A2 are particularly suitable for the present invention.

According to the invention it is therefore possible in one embodiment to use the particles with nanostructures in the electroluminescent element according to the invention, wherein in particular the targeted use of the particles with nanostructures is possible in specific layers of the EL element but also in the printing paste with which the busbars are formed.

Suitable electrically conducting materials for the electrodes are known per se to the person skilled in the art. In principle several types of electrodes are available for the production of thick-film EL elements with alternating voltage excitation. On the one hand these include indium-tin oxide electrodes (indium-tin oxides, ITO) sputtered or vapour deposited in vacuo on plastics films. They are extremely thin (a few 100 Å) and have the advantage of a high transparency combined with a relatively low sheet resistance (ca. 60 to 600 Å).

In addition printing pastes with ITO or ATO (indium-tin oxides, antimony-tin oxide) or intrinsically conducting transparent polymer pastes can be used, from which flat electrodes are formed by means of screen printing. In a thickness of ca. 5 to 20 μm such electrodes have only a slight transparency with a high sheet resistance (up to 50 kΩ). They can be applied largely in any desired structured form, including also on structured surfaces. Furthermore they can be laminated relatively easilyl. Also, non-ITO screen printed layers (in which the term “non-ITO” includes all screen printed layers that are not based on indium-tin oxide (ITO)), in other words intrinsically conducting polymeric layers containing normally nanoscale electrically conducting pigments, for example the ATO screen printing pastes with the designations 7162E or 7164 from DuPont, intrinsically conducting polymer systems such as the Orgacon® system from Agfa, the Baytron® (poly-(3,4-ethylenedioxythiophene)-system) from H. C. Starck GmbH, the Ormecon system termed organic metal (PEDT-conductive polymer polyethylene-dioxythiophene), conducting coating systems or printing Ink systems from Panipol OY and optionally with highly flexible binders, for example based on PU (polyurethanes), PMMA (polymethyl methacrylate), PVA (polyvinyl alcohol), modified polyaniline, can be used. Baytron® (poly-(3,4-ethylenedioxythiophene)-system) from H. C. Starck GmbH is preferably used as the material of the at least partially transparent element of the electroluminescent element. Examples of electrically conducting polymer films are polyanilines, polythiophenes, polyacetylenes, polypyrroles (Handbook of Conducting Polymers, 1986) with or without a metal oxide filling.

On account of its high resistance, Baytron® (poly-(3,4-ethylenedioxythiophene)-system) from H. C. Starck GmbH is particularly preferred.

In addition also tin oxide (NESA) pastes can be used as corresponding electrode material.

The electrically conducting materials described above can furthermore be applied to a carrier material. Suitable carrier materials are for example transparent glasses and thermoplastic films.

These electrode materials can be applied for example by means of screen printing, knife coating, sputtering, spraying or brushing to corresponding carrier materials (substrates), preferably followed by drying at low temperatures of for example 80° to 120° C.

In a preferred embodiment the application of the electrically conducting coating is carried out in vacuo or pyrolytically.

Particularly preferably the electrically conducting coating is a metallic or metal oxide, thin and largely transparent layer produced in vacuo or pyrolytically, which preferably has a sheet resistance of 0.1 to 1,000 Ω/square.

In addition electrically conducting glass can also be used as electrode.

A specially preferred type of electrically conducting and highly transparent glass, in particular float glass, are pyrolytically produced layers that have a high surface hardness and whose electrical surface resistance can be adjusted in a very broad range from in general a few milliohms up to 3,000 Ω/square.

Such pyrolytically coated glasses can be shaped extremely well and have a good scratch resistance, and in particular scratches do not lead to an electrical interruption of the electrically conducting surface layer, but simply to a generally slight increase in the sheet resistance.

Furthermore, pyrolytically produced conducting surface layers are diffused and anchored so strongly in the surface due to the temperature treatment, that in a subsequent material application an extremely high adhesive bonding to the glass substrate is formed, which is likewise very advantageous for the present invention. In addition such coatings exhibit a good homogeneity, and therefore only a slight variation of the sheet resistance value over large surfaces. This property is likewise an advantage for the present invention.

Electrically conducting and highly transparent thin layers can be produced substantially more efficiently and more cost-effectively on a glass substrate, which is preferably employed according to the invention, than on polymeric substrates such as PET, PMMA or PC. The rear electrode is, like the generally partially transparent electrode, a flat electrode, which however does not have to be transparent or at least partially transparent. This is generally formed from inorganically or organically based electrically conducting materials, for example from metals such as silver. Other suitable electrodes include in particular polymeric, electrically conducting coatings. In this case the coatings already mentioned hereinbefore in connection with the at least partially transparent electrode can be used. In addition those polymeric electrically conducting coatings known to the person skilled in the art that are not at least partially transparent can also be used.

Suitable materials of the rear electrode are therefore preferably selected from the group consisting of metals such as silver, carbon, ITO screen printing layers, ATO screen printing layers, non-ITO screen printing layers, in other words intrinsically conducting polymeric systems with usually nanoscale electrically conducting pigments, for example ATO screen printing pastes with the designation 7162E or 7164 from DuPont, intrinsically conducting polymer systems such as the Orgacon® system from Agfa, the Baytron® poly-(3,4-ethylenedloxythiophene)-system from H. C. Starck GmbH, the Ormecon system termed organic metal (PEDT conductive polymer polyethylene-dioxythiophene), electrically conducting coating and printing paste systems from Panipol OY and polyaniline optionally modified with highly flexible binders, for example based on PU (polyurethanes), PMMA (polymethyl methacrylate), PVA (polyvinyl alcohol), wherein metals such as sliver or carbon can be added to the aforementioned materials in order to improve the electrical conductivity and/or can be augmented with a layer of these materials.

The EL element according to the invention can include at least one insulating layer, which is arranged between an electrode and the EL layer.

Suitable dielectric layers are known to the person skilled in the art. Suitable layers often contain highly dielectrically acting powders such as for example barium titanate, which are preferably dispersed in fluorene-containing plastics or cyano-based resins. Examples of particularly suitable particles are barium titanate particles in the range preferably from 1.0 to 2.0 μm. With a high degree of filling these can produce a relative dielectric constant of up to 100.

The dielectric layer generally has a thickness of 1 to 50 μm, preferably 2 to 40 μm, particularly preferably 5 to 25 μm and especially 8 to 15 μm.

The EL element according to the invention can in one embodiment also include in addition a further dielectric layer, which layers are arranged next to one another and together improve the insulating effect, or which is interrupted by a floating electrode layer. The use of a second dielectric layer may depend on the quality and pinhole freedom of the first dielectric layer.

The expression “floating electrode layer” is understood to mean an electrode layer that is not potential-bound. In this case, two electrodes are connected to an alternating voltage in such a way that they are oppositely charged, and the electrodes preferably do not completely overlap. A “floating electrode” is thus achieved by a galvanic separation from the two electrodes connected to an alternating voltage. The electrodes can be arranged in one plane or in different planes, and can interact with a third or further electrode or electrodes arranged above, in between or underneath. An electroluminescent layer or a plurality of electroluminescent layers should be arranged between the electrodes so that luminous effects can be generated.

The EL element according to the invention includes one EL layer or several EL layers. The at least one electroluminescent (EL) layer is generally arranged between the first transparent electrode and a dielectric layer. In this connection the EL layer can be arranged directly adjoining the dielectric layer, or one or more further layers can optionally be arranged between the dielectric layer and the EL layer. Preferably the EL layer is arranged immediately adjacent to the dielectric layer.

The at least one electroluminescent EL layer can be arranged on the whole internal surface of the first partially transparent electrode or on one or more partial surfaces of the first at least partially transparent electrode. In the case where the luminous structure is arranged on a plurality of partial surfaces, the partial surfaces generally have an interspacing of 0.5 to 10.0 mm, preferably 1 to 5 mm.

The EL layer is generally composed of a binder matrix with EL pigments homogeneously dispersed therein. The binder matrix is generally chosen so as to ensure a good adhesive bonding to the electrode layer (or to the dielectric layer optionally applied thereto). In a preferred embodiment PVB-based or PU-based systems are used in this connection. Apart from the EL pigments, the binder matrix may optionally also contain further additives, such as colour-converting organic and/or inorganic systems, colour additives for a daytime and nighttime lighting effect, and/or reflecting and/or light-absorbing effect pigments such as aluminium flakes or glass flakes or mica platelets. In general the proportion of the EL pigments in the overall composition of the EL layer (degree of filling) is 20 to 75 wt. %, preferably 50 to 70 wt. %.

The EL pigments used in the EL layer generally have a thickness of 1 to 50 μm, preferably 5 to 25 μm.

The at least one EL layer is preferably an alternating current thick-film powder electroluminescent (AC-P-EL) luminous structure.

Thick-film AC-EL systems have been well known since Destriau in 1947, and are generally applied by means of screen printing to ITO-PET films. Since zinc sulfide electroluminophores experience a very high degree of degradation in operation and especially at elevated temperatures and in a water vapour atmosphere, nowadays microencapsulated EL phosphors (pigments) are used for long-life thick-film AC-EL lamp structures. It is however also possible not to use microencapsulated pigments in the EL element according to the invention, as is discussed hereinafter.

EL elements are understood in the context of the present invention to denote thick-film EL systems that are operated by alternating voltage at normally 100 volts and 400 Hz, and thereby emit a so-called cold light of a few cd/m² to several 100 cd/m² or more. EL screen printing pastes are generally used in such inorganic thick-film alternating voltage EL elements.

Such EL screen printing pastes are generally based on inorganic substances. Suitable substances are for example highly pure ZnS, CdS, ZnₓCd₁₋ₓS compounds of groups II and IV of the Periodic System of the Elements, in which connection ZnS is particularly preferably used. The aforementioned substances can be doped or activated and optionally can also be co-activated. Copper and/or manganese for example are used for the doping. The co-activation is performed for example with chlorine, bromine, iodine and aluminium. The content of alkali and rare earth materials, if these are present at all in the aforementioned substances, is generally very low. ZnS is most particularly preferably used, which is preferably doped and activated with copper and/or manganese and is preferably co-activated with chlorine, bromine, Iodine and/or aluminium.

Normal EL emission colours are orange, green, green-blue, blue-green and white, the emission colour white or red being able to be obtained by mixtures of suitable EL phosphors (pigments) or by colour conversion. The colour conversion can generally be effected in the form of a converting layer and/or by admixture of corresponding dyes and pigments in the polymeric binder of the screen printing inks and/or in the polymer matrix in which the EL pigments are incorporated.

In a further embodiment of the present invention the screen printing matrix used for the production of the EL layer is provided with glazing, colour-filtering or with colour-converting dyes and/or pigments. In this way the emission colour white or a day-night light effect can be generated.

In a further embodiment pigments are used in the EL layer that have an emission in the blue wavelength range from 420 to 480 nm and are provided with a colour-converting microencapsulation. In this way the colour white can be emitted.

In one embodiment AC-P-EL pigments that have an emission in the blue wavelength range from 420 to 480 nm are used in the EL layer. In addition the AC-P-EL screen printing matrix preferably contains wavelength-converting inorganic fine particles based on europium (II)-activated alkaline earth orthosilicate phosphors such as (Ba, Sr, Ca)₂SiO₄:Eu²⁺ or YAG phosphors such as Y₃Al₅O₁₂:Ce³⁺ or Tb₃Al₅O₁₂:Ce³⁺ or Sr₂GaS₄:Eu²⁺ or SrS:Eu²⁺ or (Y,Lu,Gd,Tb)₃(Al,Sc,Ga)₅O₁₂:Ce³⁺ or (Zn,Ca,Sr)(S,Se):Eu²⁺. In this way a white emission can be achieved.

Corresponding to the prior art the aforementioned “EL phosphor” pigments can be microencapsulated. Good half-life times can be achieved due to the inorganic microencapsulation technique. The EL screen printing system Luxprint® for EL from E.I. du Pont de Nemours and Companies may be named by way of example in this connection. Organic microencapsulation techniques and film-wrap laminates based on the various thermoplastic films are in principle also suitable, but have proved to be expensive and do not significantly prolong the service life.

Suitable zinc sulfide microencapsulated EL phosphors (pigments) are available from the company Osram Sylvania, Inc. Towanda under the trade name GlacierGLO™ Standard, High Brite and Long Life, and from the Durel Division of the Rogers Corporation under the trade names 1PHS001® High-Efficiency Green Encapsulated EL Phosphor, 1PHS002® High-Efficiency Blue-Green Encapsulated EL Phosphor, 1PHS003® Long-Life Blue Encapsulated EL Phosphor, 1PHS004® Long-Life Orange Encapsulated EL Phosphor.

The mean particle diameters of the suitable microencapsulated pigments in the EL layer are generally 15 to 60 μm, preferably 20 to 35 μm.

Non-microencapsulated, fine-grain EL pigments, preferably with a high service life, can also be used in the EL layer of the EL element according to the invention. Suitable non-microencapsulated fine-grain zinc sulfide EL phosphors are disclosed for example in U.S. Pat. No. 6,248,261 and in WO 01/34723. These preferably have a cubic crystal lattice structure. The non-microencapsulated pigments preferably have mean particle diameters of 1 to 30 um, more preferably 2 to 15 um, most particularly preferably 5 to 10 μm.

Specifically, non-microencapsulated EL pigments can be used in smaller pigment sizes down to less than 10 μm. The transparency of the glass element can thereby be increased.

Non-encapsulated pigments can thus be admixed with the suitable screen printing inks according to the present invention, preferably having regard to the special hygroscopic properties of the pigments, preferably the ZnS pigments. Generally, in this connection binders are used that have on the one hand a good adhesion to so-called ITO layers (indium-tin oxide) or have intrinsically conducting polymeric transparent layers, and which furthermore have a good insulating effect, strengthen the dielectric material, and thus improve the breakdown strength at high electrical field strengths, and in addition in the cured state have a good water vapour barrier effect and furthermore protect the phosphor pigments and prolong the service life.

The half-life times of the suitable pigments in the EL layer, in other words the time during which the initial brightness of the EL element according to the invention has fallen by half, are in general at 100 or 80 volts and 400 Hz, 400 hours to at most 5,000 hours, but are normally not more than 1,000 to 3,500 hours.

The brightness values (EL emission) are generally 1 to 200 cd/m², preferably 3 to 100 cd/m², and with large luminous surfaces are particularly preferably in the range from 1 to 20 cd/m².

Pigments with longer or shorter half-life times and higher or lower brightness values in the EL layer of the EL element according to the invention can however also be used.

In a further embodiment of the present invention the pigments present in the EL layer have such a small mean particle diameter, or have such a low degree of filling in the EL layer, or the individual EL layers are geometrically configured so small, or the interspacing of the individual EL layers is chosen so large, that the EL element in the case of a non-electrically activated luminous structure is configured so as to be at least partially transparent or so as to ensure transparency. Suitable pigment particle diameters, degrees of filling, dimensions of the luminous elements and interspacings of the luminous elements are mentioned hereinbefore.

The EL element according to the invention can include substrates, such as for example glasses, plastics films or the like, on one or on both sides on the respective electrodes.

With the EL element according to the invention it is preferred if at least the substrate that is in contact with the transparent electrode is graphically translucently glazed on the inside and is opaque on the covering side.

In addition it is preferred if the substrate that is in contact with the transparent electrode is a film that can be cold-stretchably shaped below the glass transition temperature Tg. This provides the possibility of shaping the resulting EL element three-dimensionally.

In addition it is preferred if the substrate that is in contact with the rear electrode is a film that can likewise be cold-stretchably shaped below Tg. This provides the possibility of shaping the resulting EL element three-dimensionally.

The production of the electroluminescent element according to the invention is carried out substantially according to methods that are known from the prior art for the production of electroluminescent elements.

Normally the aforementioned luminous pigment pastes (screen printing pastes) are applied to transparent plastics films or glasses, which in turn include a largely transparent electrically conducting coating and thereby form the electrode for the visible side. The dielectric material and the rear side electrode are then produced by printing techniques and/or lamination techniques.

A reverse production process is however also possible, in which first of all the rear side electrode is produced or the rear side electrode is used in the form of a metallised film and the dielectric material is applied to this electrode. The EL layer, and following this the transparent and electrically conducting upper electrode, are then applied. The resultant system can then be optionally laminated with a transparent cover film and thereby protect against water vapour and also against mechanical damage. The EL layer is normally applied by printing techniques by means of screen printing or dispenser application or ink-jet application, or also by a knife coating procedure or a rolling coating method or a curtain casting method or a transfer method, preferably by means of screen printing. Preferably the EL layer is applied to the surface of the electrode or to the insulating layer optionally applied to the electrode.

Following this, in general at least two alternating voltage feeders are attached to two sites arranged spaced apart from one another on at least one of the flat electrodes.

In a first particularly preferred embodiment of the present invention the electroluminescent element consists of the following layers (normal structure):
a) an at least partially transparent substrate, component A,
b) at least one electroluminescent arrangement, component B, applied to the substrate and containing the following components
   ba) an at least partially transparent electrode, component BA, as front electrode,
   bb) optionally an insulating layer, component BB,
   bc) a layer containing at least one luminous pigment (electroluminophore) excitable by an electrical field, termed an electroluminescent layer or pigment layer, component BC,
   bd) optionally an insulating layer, component BD, be) a rear electrode, component BE, which can be at least partially transparent,
   bf) a conducting track or a plurality of conducting tracks, component BF, for the electrical contacting of both component BA as well as component BE, wherein the conducting track or the conducting tracks can be applied before, after or between the electrodes BA and BE, the conducting track or the conducting tracks preferably being applied in one work step. The conducting track or conducting tracks can be applied in the form of a silver bus, preferably produced from a silver paste, a graphite layer can possibly also be applied before the application of the silver bus
c) a protective layer, component CA, or a film, component CB.

The insulating layers BB and BD can be non-transparent, opaque or transparent, in which connection at least one of the layers must be at least partially transparent if two insulating layers are present.

Also, one or more at least partially transparent graphically configured layers can be arranged externally on the substrate A and/or between the substrate A and the electroluminescent arrangement.

Apart from the aforementioned layers (components A, B and C) the electroluminescent element according to the invention (conventional structure) can comprise one or more reflecting layers. The reflecting layer or layers can in particular be arranged as follows:
externally on the component A,
between the component A and component BA,
between the component BA and component BB, or BC if there is no component BB,
between the component BD and component BE,
between the component BE and component BF,
between the component BF and component CA or CB,
externally on the component CA or CB.

Preferably the reflecting layer, where present, is arranged between the component BC and BD, or BE if there is no component BD.

The reflecting layer preferably includes glass spheres, in particular hollow glass spheres. The diameter of the glass spheres can vary within wide ranges. For example, they can have a size d₅₀ of in general 5 μm to 3 mm, preferably 10 to 200 μm, particularly preferably 20 to 100 μm. The hollow glass spheres are preferably embedded in a binder.

In an alternative embodiment of the present invention the electroluminescent element consists of the following layers (reverse layer structure):
a) an at least partially transparent substrate, component A,
b) at least one electroluminescent arrangement, component B, applied to the substrate and containing the following components
   be) a rear electrode, component BE, that can be at least partially transparent,
   bb) optionally an insulating layer, component BB,
   bc) a layer containing at least one luminous pigment (electroluminophore) that can be excited by an electrical field, called the electroluminescent layer or pigment layer, component BC,
   bd) optionally an insulating layer, component BD,
   ba) an at least partially transparent electrode, component BA, as front electrode,
   bf) a conducting track or plurality of conducting tracks, component BF, for the electrical contacting of component BA as well as of component BE, wherein the conducting track or conducting tracks can be applied before, after or between the electrodes BA and BE, wherein preferably the conducting track or conducting tracks are applied in one work step. The conducting track or conducting tracks can be applied in the form of a silver bus, preferably produced from a silver paste. A graphite layer can possibly also be applied before the application of the silver bus,
c) an at least partially transparent protective layer, component CA and/or a film, component CB.

Also, one or more at least partially transparent graphically configured layers can be arranged on the transparent protective layer C and/or between the transparent protective layer C and the EL arrangement.

In particular, the graphically configured layers can take over the function of the protective layer.

In a particular embodiment of the reverse layer structure the structures B, C mentioned above can be applied to the front side of the substrate, component A, as well as to the rear side, or also to both sides of the substrate (double-sided structure). The layers BA to BF can be identical on both side, but can be different in one or more layers, so that for example the electroluminescent element radiates uniformly on both sides or the electroluminescent element on each side has a different colour and/or a different brightness and/or a different graphical configuration.

In addition to the aforementioned layers (components A, B and C) the electroluminescent element according to the Invention with a reverse layer structure can include one or more reflecting layers.

The reflecting layer or layers can in particular be arranged as follows:
externally on component A,
between component A and component BE,
between component BE and component BB,
between component BB and component BC,
between component BC and component BD,
between component BD and component BA,
between component BA and component BF,
between component BF and component CA or CB,
on component CA or CB.

Preferably the reflecting layer, where present, is arranged between component BC and component BB, or BE if component BB is not present.

For the person skilled in the art it is obvious that the particular embodiments and features mentioned for the conventional structure apply as appropriate, unless otherwise stated, to the reverse layer structure and to the double-sided structure.

The one or more insulating layers BB and/or BD in both the conventional structure as well as in the reverse structure can in particular be omitted if the component BC has a layer thickness that prevents a short circuit between the two electrodes, i.e. components BA and BE.

The features of the individual components of the EL element are described hereinafter:

### Electrodes

The EL element according to the invention comprises a first, at least partially transparent, front electrode BA and a second electrode, the rear electrode BE.

The expression “at least partially transparent” is understood in the context of the present invention to denote an electrode that is constructed of a material that has a transmission of in general more than 60%, preferably more than 70%, particularly preferably more than 80% and especially more than 90%.

The rear electrode BE need not necessarily be transparent.

Suitable electrically conducting materials for the electrodes are known to the person skilled in the art. In principle several types of electrodes are available for the production of thick-film EL elements exhibiting alternating voltage excitation. These include on the one hand indium-tin oxide electrodes (indium-tin oxides, ITO) applied by sputtering or vapour deposition to plastics films. They are extremely thin (a few 100 Å) and have the advantage of a high transparency combined with a relatively low sheet resistance (ca. 60 to 600Ω).

Furthermore printing pastes with ITO or ATO (indium-tin oxides, antimony-tin oxide) or intrinsically conducting transparent polymer pastes can be used, from which flat electrodes can be produced by means of screen printing. They can be applied largely in any desired structural shape, and indeed also on structured surfaces. In addition they have a relatively good laminability. Also, non-ITO screen printing layers (wherein the term “non-ITO” includes all screen printing layers that are not based on indium-tin oxide (ITO)), in other words intrinsically conducting polymeric layers with normally nanoscale electrically conducting pigments, can be used. For example, the ATO screen printing pastes with the designations 7162E or 7164 from DuPont, intrinsically conducting polymer systems, such as the Orgacon® system from Agfa, the Clevios® poly-(3,4-ethylenedioxythiophene)-system from H. C. Starck GmbH, the Ormecon system termed organic metal (PEDT-conductive polymer polyethylene-dioxythiophene), conducting coating or printing paste systems from Panipol OY and optionally with highly flexible binders, for example based on PU (polyurethanes), PMMA (polymethyl methacrylate), PVA (polyvinyl alcohol), or modified polyaniline, can be used. Preferably the Clevios® poly-(3,4-ethylenedioxythiophene)-system from H. C. Starck GmbH is used as the material of the at least partially transparent electrode of the electroluminescent element. Examples of electrically conducting polymer films are polyanilines, polythiophenes, polyacetylenes, polypyrroles (Handbook of Conducting Polymers, 1986), with and without a metal oxide filling.

According to the invention, 10 to 90 wt. %, preferably 20 to 80 wt. %, particularly preferably 30 to 65 wt. %, in each case referred to the total weight of the printing paste, of Clevios P, Clevios PH, Clevios P AG, Clevios P HCV4, Clevios P HS, Clevios PH 500, Clevios PH 510 or arbitrary mixtures thereof, are preferably used for the formulation of a printing paste for the production of the at least partially transparent electrode BA. Dimethyl sulfoxide (DMSO), N,N-dimethylformamide, N,N-dimethylacetamide, ethylene glycol, glycerol, sorbitol, methanol, ethanol, isopropanol, n-propanol, acetone, methyl ethyl ketone, dimethylaminoethanol, water or mixtures of two, three or more of the aforementioned compounds can be used as solvent. The amount of solvent can vary in wide ranges in the printing paste. For example, one formulation according to the invention of a paste can contain 55 to 60 wt. % of solvent, whereas in another formulation according to the invention about 35 to 45 wt. % of a solvent mixture of two or more solvents can be used. Furthermore Silquest A187, Neo Rez R986, Dynol 604 and/or mixtures of two or more of these substances can be included as surfactant additive and bonding activator. The amount of these substances is 0.1 to 5.0 wt,%, preferably 0.3 to 2.5 wt. %, referred to the total weight of the printing paste.

As binder, the formulation can contain for example Bayderm Finish 85 UD, Bayhydrol PR340/1, Bayhydrol PR135 or arbitrary mixtures thereof, preferably in amounts of about 0.5 to 10 wt. %, preferably 3 to 5 wt,%. The polyurethane dispersions used according to the invention, which after the drying of the layer form the binder for the conducting layer, are preferably aqueous polyurethane dispersions.

According to the invention, particularly preferred formulations of printing pastes for the production of the partially transparent electrode BA contain:

| | Content/ | Content/ | Content/ | Content/ |
|---|---|---|---|---|
| Substance | wt. % | wt. % | wt. % | wt. % |
| Clevlos P HS | 33 | 48 | 40 | 42.2 |
| (H. C. Starck) | | | | |
| Silquest A187 (OSi | 0.4 | 0.5 | 1.2 | 1.0 |
| Specialties) | | | | |
| N-methyl- | 23.7 | 14.4 | 10.3 | 13.3 |
| pyrrolidone | | | | |
| Diethylene glycol | 26.3 | 20.7 | 30.0 | 25.4 |
| Proglyde/DMM | 12.6 | 12.4 | 14.5 | 13.6 |
| Bayderm Finish 85 | 4.0 | 4.0 | 4.0 | 4.5 |
| UD (Lanxess) | | | | |

| Substance | Content/wt. % | Content/wt. % |
|---|---|---|
| Clevios P HS (H. C. Starck) | 33 | 40 |
| Silquest A187 (OSi | 0.4 | 1.2 |
| Specialties) | | |
| N-methyl-pyrrolidone | 23.7 | 10.3 |
| Diethylene glycol | 26.3 | 30.0 |
| Proglyde/DMM | 12.6 | 14.5 |
| Bayhydrol P340/1 | 4.0 | 4.0 |

By way of departure from the formulations mentioned above for the partially transparent electrode BA, the following ready-for-use, commercially obtainable printing pastes mentioned here by way of example can also be used according to the invention as finished formulations: the Orgacon EL-P1000, EL-P3000, EL-P5000 or EL-P6000 range from Agfa, preferably the EL-P3000 and EL-P6000 range (in particular for formable uses).

These electrode materials can be applied for example by means of screen printing, knife coating, sputtering, spraying and/or brushing on corresponding carrier materials (substrates), which are then preferably dried at low temperatures of for example 80° to 120° C.

In a preferred alternative embodiment the application of the electrically conducting coating is carried out in vacuo or pyrolytically.

Particularly preferably in the alternative embodiment the electrically conducting coating is a metallic or metal oxide, thin and largely transparent layer produced in vacuo or pyrolytically, which preferably has a sheet resistance of 5 mΩ to 3,000 Ω/square, particularly preferably a sheet resistance of 0.1 to 1,000 Ω/square, most particularly preferably 5 to 30 Ω/square, and in a further preferred embodiment has a daylight transmissibility at least greater than 60% (>60 to 100%) and in particular greater than 76% (>76 to 100%).

Furthermore electrically conducting glass can also be used as electrode.

A particularly preferred type of electrically conducting and highly transparent glass, in particular float glass, are pyrolytically produced layers that have a high surface hardness and whose electrical surface resistance can be adjusted in a very wide range from in general a few milliohms up to 3,000 Ω/square.

Such pyrolytically coated glasses can be readily shaped/formed and have a good scratch resistance, and in particular scratches do not lead to an electrical interruption of the electrically conducting surface layer, but simply to a generally slight increase of the sheet resistance.

Furthermore, pyrolytically produced conducting surface layers are due to the heat treatment diffused to such a large extent and anchored in the surface that in a subsequent material application an extremely high adhesive bonding with the glass substrate is produced, which is likewise very advantageous for the present invention. In addition such coatings have a good homogeneity, and therefore only a slight variation in the surface resistance over large surfaces. This property is likewise an advantage for the present invention.

Electrically conducting and highly transparent thin layers can be produced substantially more efficiently and cost-effectively on a glass substrate, which is preferably used according to the invention, than on polymeric substrates such as PET, PMMA or PC. The electrical sheet resistance is in the case of glass coatings on average more favourable by a factor of 10 than on a polymeric film of comparable transparency, is for example 3 to 10 ohm/square in the case of glass layers compared to 30 to 100 Ω/square on PET films.

The rear electrode component BE is—as in the case of the at least partially transparent electrode—a flat electrode, which however need not be transparent or at least partially transparent. This is in general applied to the insulating layer, if present. If no insulating layer is present, then the rear electrode is applied to the layer containing at least one luminous substance that can be excited by an electrical field. In an alternative embodiment the rear electrode is applied to the substrate A.

The rear electrode is in general formed from electrically conducting materials based on inorganic or organic substances, for example from metals such as silver, wherein preferably those materials are used that are not damaged if the isostatic high-pressure forming process is used to produce the three-dimensionally formed sheet element according to the invention. Suitable electrodes include furthermore in particular polymeric electrically conducting coatings. In this case the coatings already mentioned in connection with the at least partially transparent electrode can be used. Moreover, those polymeric electrically conducting coatings known to the person skilled in the art that are not at least partially transparent, can be employed.

The formulation of the printing paste for the rear electrode can in this connection correspond to that of the partially transparent electrode.

By way of departure from this formulation, the following formulation can however also be used according to the invention for the rear electrode.

30 to 90 wt,%, preferably 40 to 80 wt,%, particularly preferably 50 to 70 wt,%, in each case referred to the total weight of the printing paste, of the conducting polymers Clevios P, Clevios PH, Clevios P AG, Clevios P HCV4, Clevios P HS, Clevios PH, Clevios PH 500, Clevios PH 510 or arbitrary mixtures thereof, are used for the formulation of a printing paste for the production of the rear electrode. Dimethyl sulfoxide (DMSO), N,N-dimethylformamide, N,N-dimethylacetamide, ethylene glycol, glycerol, sorbitol, methanol, ethanol, isopropanol, n-propanol, aceton, methyl ethyl ketone, dimethylaminoethanol, water or mixtures of two, three or more of these solvents can be used as solvent. The amount of solvent that is used can vary in wide ranges. Thus, one formulation of a paste according to the invention can contain 55 to 60 wt. % of solvent, whereas in another formulation according to the invention about 40 wt. % of a solvent mixture of three solvents is used. Furthermore, Silquest A187, Neo Rez R986, Dynol 604 or mixtures of two or more of these substances can be used as surfactant additive and bonding activator, preferably in an amount of 0.7 to 1.2 wt. %. The formulation can contain for example 0.5 to 1.5 wt. % of UD-85, Bayhydrol PR340/1, Bayhydrol PR135 or arbitrary mixtures thereof as binder.

In a further embodiment according to the invention the rear electrode can be filled with graphite. This can be accomplished by adding graphite to the formulations described above. By way of departure from the formulation mentioned above for the rear electrode, the following ready-for-use, commercially obtainable printing pastes already mentioned here by way of example can also be used according to the invention: the Orgacon EL-P1000, EL-P3000, EL-P5000 or EL-P6000 range from Agfa, preferably the EL-P3000 and EL-P6000 range (for formable uses). Graphite can also be added in this case.

The printing pastes of the Orgacon EL-P4000 range, in particular Orgacon EL-P4010 and EL-4020, can also be used specifically for the rear electrode. Both can be mixed with one another in any desired ratio. Orgacon EL-P4010 and EL-4020 already contain graphite.

Graphite pastes that can be obtained commercially, for example graphite pastes from Acheson, in particular Electrodag 965 SS or Electrodag 6017 SS, can be used as rear electrode.

A particularly preferred formulation according to the invention of a printing paste for producing the rear electrode BE contains:

| Substance | Content/wt.-% | Content/wt.-% | Content/wt.-% |
|---|---|---|---|
| Clevios P HS | 58.0 | 50.7 | 64.0 |
| Silquest A187 | 2.0 | 1.0 | 1.6 |
| NMP (e.g. BASF) | 17.0 | 12.1 | 14.8 |
| DEG | 10.0 | 23.5 | 5.9 |
| DPG/DMM | 10.0 | 8.6 | 10.2 |
| Bayderm Finish 85 | 3.0 | 4.1 | 3.5 |
| UD (Lanxess) | | | |

| Substance | Content/wt.-% | Content/wt.-% |
|---|---|---|
| Clevios P HS | 58.0 | 50.7 |
| Silquest A187 | 2.0 | 1.0 |
| NMP (e.g. BASF) | 17.0 | 12.1 |
| DEG | 10.0 | 23.5 |
| DPG/DMM | 10.0 | 8.6 |
| Bayhydrol P340/1 | 3.0 | 4.1 |

### Conducting Tracks, Connections of the Electrodes

In the case of large area luminous elements with a luminous capacitor structure, the surface conductivity plays a significant role as regards a uniform luminous density. In the case of large area luminous elements so-called busbars are frequently used as conducting tracks, i.e. component BF, especially with semiconducting LEPs (light-emitting polymers), PLED and/or OLED systems, in which relatively large currents flow. In this case very highly electrically conducting tracks are formed in the manner of a cross. In this way a large surface area for example is subdivided into four small areas. The voltage drop in the middle region of a luminous surface is thereby significantly reduced and the uniformity of the luminous density and the decrease in brightness in the centre of a luminous field is also reduced.

In the case of a zinc sulfide particular EL field employed in one embodiment according to the invention, in general alternating voltages greater than 100 volts and up to more than 200 volts are applied, and very low currents flow if a good dielectric material or good insulation are employed. In the ZnS thick-film AC-EL element according to the invention the problem of current loading is therefore substantially less than in the case of semiconducting LEP or OLED systems, so that the use of busbars is not absolutely essential, but instead large area luminous elements can already be installed without using busbars.

Preferably according to the Invention it is sufficient if the silver bus in the case of areas smaller than DIN A3 is printed only on the edge of the electrode layer BA or BE; with areas larger than DIN A3 it is preferred according to the invention if the silver bus forms at least an additional conducting track.

The electrical connections can be produced for example by using electrically conducting and stovable pastes containing tin, zinc, silver, palladium, aluminium and further suitable conducting metals, or combinations and mixtures or alloys thereof.

In this connection the electrically conducting contact strips are in general applied by means of screen printing, brush application, ink-jet, knife coating, roller application, spraying, or by means of dispenser application or comparable application methods known to the person skilled in the art, to the electrically conducting and at least partially transparent thin coatings, and are then generally heat treated in an oven so that strips normally laterally applied along a substrate edge can be effectively contacted in an electrically conducting manner by means of soldering, clamping or plug-in connection.

So long as only very small electrical outputs have to be initiated on electrically conducting coatings, spring contacts or carbon-filled rubber elements or so-called zebra rubber strips are sufficient.

Pastes based on silver, palladium, copper or gold-filled polymer adhesives are preferably used as conducting adhesive pastes. Self-adhesive, electrically conducting strips of for example tin-plated copper foil with an electrically conducting adhesive in the z-direction can likewise be applied by contact pressing.

The adhesive layer is in this case generally uniformly pressed in by exerting a few N/cm² surface pressure, and depending on the actual implementation, values of 0.013 ohm/cm² (for example conductive copper foil tape VE 1691 from the company D & M International, A-8451 Heimschuh) or 0.005 ohm (for example type 1183 from 3M Electrical Products Division, Austin, Tex. USA; according to MIL-STD-200 Method 307 maintained at 5 psi/3.4 N/cm² measured over 1 sq.in. surface area) or 0.001 ohm (for example type 1345 from the 3M company) or 0.003 ohm (for example type 3202 from the Holland Shielding Systems BV company) are thereby achieved.

The contacting can however be carried out by all conventional methods known to the person skilled in the art, for example crimping, plugging in, clamping, riveting or bolting/screwing.

### Dielectric Layer

The EL element according to the invention preferably comprises at least one dielectric layer, component BD, which is provided between the rear electrode, component BE, and the EL layer, component BC.

Suitable dielectric layers are known to the person skilled in the art. Suitable layers often include highly dielectrically acting powders, such as for example barium titanate, which are preferably dispersed in fluorene-containing plastics or in cyano-based resins. Examples of particularly suitable particles are barium titanate particles in the range of preferably 1.0 to 2.0 μm. With a high degree of filling these can produce a relative dielectric constant of up to 100.

The dielectric layer has a thickness of generally 1 to 50 μm, preferably 2 to 40 μm, particularly preferably 5 to 25 μm, especially 8 to 15 μm.

The EL element according to the invention can in one embodiment also additionally contain a further dielectric layer, which layers are arranged above one another and together improve the insulation effect, or which is interrupted by a floating electrode layer. The use of a second dielectric layer can depend on the quality and pinhole freedom of the first dielectric layer.

As fillers, inorganic insulating materials are used, which are known to the person skilled in the art from the literature and include for example: BaTiO₃, SrTiO₃, KNbO₃, PbTiO₃, LaTaO₃, LiNbO₃, GeTe, Mg₂TiO₄, Bl₂(TiO₃)₃, NiTiO₃, CaTiO₃, ZnTiO₃, Zn₂TiO₄, BaSnO₃, Bl(SnO₃)₃, CaSnO₃, PbSnO₃, MgSnO₃, SrSnO₃, ZnSnO₃, BaZrO₃, CaZrO₃, PbZrO₃, MgZrO₃, SrZrO₃, ZnZrO₃ and lead zirconate-titanate mixed crystals or mixtures of two or more of these fillers. Preferred fillers according to the invention are BaTiO₃ or PbZrO₃ or mixtures thereof, preferably in filling amounts of 5 to 80 wt. %, preferably 10 to 75 wt. %, particularly preferably 40 to 70 wt. %, in each case referred to the total weight of the paste, in the paste used to produce the insulating layer.

One-component or preferably two-component polyurethane systems can be used as binder for this layer, preferably the systems available from Bayer MaterialScience AG, particularly preferably Desmodur and Desmophen or the lacquer raw materials of the Lupranate, Lupranol, Pluracol or Lupraphen range from BASF AG; from Degussa AG (Evonik), preferably vestanate, particularly preferably vestanate T and B; or from the Dow Chemical Company, preferably vorastar. Furthermore highly flexible binders can also be used, for example those based on PMMA, PVA, in particular mowiol and poval from Kuraray Specialties Europe GmbH or polyviol from Wacker AG, or PVB, in particular mowital from Kuraray Specialties Europe GmbH (B 20H, B 30 T, B 30H, B 30 HH, B 45H, B 60 T, B 60H, B 60 HH, B 75H), or pioloform, in particular pioloform BR18, BM18 or BT18, from Wacker AG.

As solvent there may for example be used ethyl acetate, butyl acetate, 1-methoxypropyl acetate-2, toluene, xylene, solvesso 100, shellsol A or mixtures of two or more of these solvents. If for example PVB is used as binder, the paste can also contain methanol, ethanol, propanol, isopropanol, diacetone alcohol, benzyl alcohol, 1-methoxypropanol-2, butyl glycol, methoxybutanol, dowanol, methoxypropyl acetate, methyl acetate, ethyl acetate, butyl acetate, butoxyl, glycolic acid n-butyl ester, acetone, methyl ethyl ketone, methyl isobutyl ketone, cyclohexanone, toluene, xylene, hexane, cyclohexane, heptane, as well as mixtures of two or more of the aforementioned solvents, in amounts of 1 to 30 wt. % referred to the total weight of the paste, preferably 2 to 20 wt. %, particularly preferably 3 to 10 wt. % Furthermore additives such as flow improvers and rheology additives can be added in order to improve the properties. Examples of flow improvers are Additoi X1480 in butoxyl in a mixing ratio of 40:60 to 60:40. The paste can contain as further additives 0.01 to 10 wt. %, preferably 0.05 to 5 wt. %, particularly preferably 0.1 to 2 wt. %, in each case referred to the total weight of paste. As rheology additives, which reduce the settling behaviour of pigments and fillers in the paste, there can for example be used BYK 410, BYK 411, BYK 430, BYK 431 or arbitrary mixtures thereof.

Particularly preferred formulations according to the invention of a printing paste for the production of the insulating layer as component BB and/or BID contain:

| | Content/ | Content/ | Content/ | Content/ |
|---|---|---|---|---|
| Substance | wt. % | wt. % | wt. % | wt. % |
| BaTiO₃ | 50 | 50 | 50 | 55 |
| Desmophen 1800 (BMS) | 25 | 25 | 25 | 22.5 |
| Desmodur L67 MPA/X | 14 | 14 | 14 | 11.4 |
| (BMS) | | | | |
| Ethoxypropyl acetate | 8.7 | 0 | 4 | 0 |
| Methoxypropyl acetate | 0 | 8.7 | 4.7 | 8.6 |
| Additol XL480 | 2.3 | 2.3 | 2.3 | 2.5 |
| (50 wt. % in butoxyl) | | | | |
| | Content/ | Content/ | Content/ | Content/ |
| Substance | wt. % | wt. % | wt. % | wt. % |
| BaTiO₃ | 55 | 56.6 | 59.9 | 59.9 |
| Desmophen 1800 (BMS) | 22.5 | 20.3 | 19.9 | 19.9 |
| Desmodur L67 MPA/X | 11.4 | 12.5 | 11.2 | 11.2 |
| (BMS) | | | | |
| Ethoxypropyl acetate | 8.6 | 7.6 | 5.7 | 0 |
| Methoxypropyl acetate | 0 | 0 | 0 | 5.7 |
| Additol XL480 in | 2.5 | 3.0 | 3.3 | 3.3 |
| butoxyl 50% | | | | |

| | Content/ | | Content/ |
|---|---|---|---|
| Substance | wt. % | Substance | wt. % |
| BaTiO₃ | 55 | BaTiO₃ | 60.2 |
| Desmophen 1800 (BMS) | 22.5 | Desmophen 670 | 14.3 |
| | | (BMS) | |
| Desmodur L67 MPA/X | 12 | Desmodur N75MPA | 12.3 |
| (BMS) | | (BMS) | |
| Ethoxypropyl acetate | 8 | Ethoxypropyl acetate | 10.3 |
| Additol XL480 | 2.5 | Additol XL480 (50 wt. | 2.9 |
| (50 wt. % in butoxyl) | | % in butoxyl) | |

### EL Layer

The EL element according to the invention includes at least one EL layer, component BC. The at least one EL layer can be arranged on the whole internal surface of the first partially transparent electrode or on one or more partial surfaces of the first at least partially transparent electrode. In the case where the EL layer is arranged on several partial surfaces, the partial surfaces generally have a mutual interspacing of 0.5 to 10.0 mm, preferably 1 to 5 mm.

The EL layer is in general composed of a binder matrix with EL pigments homogeneously dispersed therein. The binder matrix is generally chosen so as to produce a good adhesive bonding to the electrode layer (or to the dielectric layer optionally applied thereto). In a preferred implementation PVB-based or PU-based systems are used for this purpose. In addition to the EL pigments optionally further additives may also be present in the binder matrix, such as colour-converting organic and/or inorganic systems, colorant additives for a daytime and nighttime light effect and/or reflecting and/or light-absorbing effect pigments such as aluminium flakes, glass flakes or mica platelets.

The EL pigments used in the EL layer have in general a thickness of 1 to 50 μm, preferably 5 to 25 μm.

Preferably the at least one EL layer BC is an alternating current thick-film powder electroluminescent (AC-P-EL) luminous structure.

Thick-film AC-EL systems have been well known since Destriau in 1947, and are applied to ITO-PET films generally by means of screen printing. Since zinc sulfide electroluminophores experience a very high degradation in operation and specifically at elevated temperatures and in a water vapour atmosphere, nowadays in general microencapsulated EL pigments are used for long-life thick-film AC-EL lamp structures. It is however also possible to use non-microencapsulated pigments in the EL element according to the Invention, as is discussed further hereinafter.

EL elements are understood in the context of the present invention to mean thick-film EL systems that are operated by means of alternating voltage at normally 100 volts and 400 Hz and in this way emit a so-called cold light of a few cd/m² up to several 100 cd/m². EL screen printing pastes are generally used in such inorganic thick-film alternating voltage EL elements.

Such EL screen printing pastes are generally formulated on the basis of Inorganic substances. Suitable substances are for example highly pure ZnS, CdS, ZnₓCd₁₋ₓS compounds of groups II and IV of the Periodic System of the Elements, ZnS being particularly preferably used. The aforementioned substances can be doped or activated and optionally also co-activated. Copper and/or manganese for example are used for the doping. The co-activation is carried out for example with chlorine, bromine, iodine and aluminium. The content of alkali metals and rare earth metals in the aforementioned substances is generally very low, if these are present at all. Most particularly preferably ZnS is used, which is preferably doped or activated with copper and/or manganese and is preferably co-activated with chlorine, bromine, iodine and/or aluminium.

Normal EL emission colours are yellow, orange, green, green-blue, blue-green and white, the emission colours white or red being able to be obtained by mixtures of suitable EL pigments or by colour conversion. The colour conversion can generally be implemented in the form of a converting layer and/or by admixture of appropriate dyes and pigments in the polymeric binder of the screen printing inks or in the polymeric matrix in which the EL pigments are incorporated.

In a further embodiment of the present invention the screen printing matrix used for the production of the EL layer is provided with glazing, colour-filtering or colour-converting dyes and/or pigments. The emission colour white or a day/night light effect can be generated in this way.

In a further embodiment pigments are used in the EL layer that have an emission in the blue wavelength range from 420 to 480 nm and are provided with a colour-converting microencapsulation. The colour white can be emitted in this way.

In one embodiment, as pigments in the EL layer AC-P-EL pigments are used that have an emission in the blue wavelength range from 420 to 480 nm. In addition the AC-P-EL screen printing matrix preferably contains wavelength-converting inorganic fine particles based on europium(II)-activated alkaline earth orthosilicate luminous pigments such as (Ba, Sr, Ca)₂SiO₄:Eu²⁺ or YAG luminous pigments such as Y₃Al₅O₁₂:Ce³⁺ or Tb₃Al₅O₁₂:Ce³⁺ or Sr₂GaS₄:Eu²⁺ or SrS:Eu²⁺ or (Y,Lu,Gd,Tb)₃(Al,Sc,Ga)₅O₁₂:Ce³⁺ or (Zn,Ca,Sr)(S,Se):Eu²⁺. A white emission can also be achieved in this way.

Corresponding to the prior art the aforementioned EL pigments can be microencapsulated. Due to the inorganic microencapsulation techniques good half-life times can be achieved. The EL screen printing system Luxprint® for EL from E.I. du Pont de Nemours and Companies may be mentioned here by way of example. Organic microencapsulation techniques and film-wrap laminates based on the various thermoplastic films are in principle also suitable, but have however proved to be expensive and do not significantly prolong the service life.

Suitable zinc sulfide microencapsulated EL luminous pigments are available from Osram Sylvania, Inc. Towanda under the trade names GlacierGLO™ Standard, High Brite and Long Life and from the Durel Division of the Rogers Corporation, under the trade names 1PHS001®

High-Efficiency Green Encapsulated EL Phosphor, 1PHS002® High-Efficiency Blue-Green Encapsulated EL Phosphor, 1PHS003® Long-Life Blue Encapsulated EL Phosphor, 1PHS004® Long-Life Orange Encapsulated EL Phosphor.

The mean particle diameters of the suitable microencapsulated pigments in the EL layer are in general 15 to 60 μm, preferably 20 to 35 μm.

Non-microencapsulated fine grain EL pigments, preferably with a high service life, can also be used in the EL layer of the EL element according to the invention. Suitable non-microencapsulated fine grain zinc sulfide EL pigments are disclosed for example in U.S. Pat. No. 6,248,261 and in WO 01/34723. These preferably have a cubic crystal lattice structure. The non-microencapsulated pigments preferably have mean particle diameters of 1 to 30 um, particularly preferably 3 to 25 μm, most particularly preferably 5 to 20 μm.

Specifically, non-microencapsulated EL pigments with smaller pigment dimensions down to below 10 μm can be used. The transmissibility of the glass element can thereby be increased.

Thus, unencapsulated pigments can be admixed with the suitable screen printing inks according to the present invention, preferably having regard to the special hygroscopic properties of the pigments, preferably the ZnS pigments. In this connection in general binders are used that on the one hand have a good adhesion to so-called ITO layers (indium-tin oxide layers) or to intrinsically conducting polymeric transparent layers, and that on the other hand have a good insulating effect, strengthen the dielectric and thereby effect an improvement of the breakdown strength at high electric field strengths, and in addition in the cured state exhibit a good water vapour barrier effect and additionally protect the EL pigment and prolong the service life.

In one embodiment of the present invention pigments that are not microencapsulated are used in the AC-P-EL luminous layer.

The half-life times of the suitable pigments in the EL layer, i.e. the time during which the initial brightness of the EL element according to the invention has fallen by half, are in general at 100 volts and 80 volts and 400 Hz, 400 hours up to at most 5,000 hours, but normally not more than 1,000 to 3,500 hours.

The brightness values (EL emission) are in general 1 to 200 cd/m², preferably 3 to 100 cd/m², particularly preferably 5 to 40 cd/m²; with large luminous surface areas the brightness values are preferably in the range from 1 to 50 cd/m².

Pigments with longer or shorter half-life times and higher or lower brightness values can however also be used in the EL layer of the EL element according to the invention.

In a further embodiment of the present invention the pigments present in the EL layer have such a small mean particle diameter, or such a low degree of filling in the EL layer, or the individual EL layers are configured geometrically so small, or the interspacing of the individual layers is chosen so large, that the EL element in the case of non-electrically activated luminous structures is configured to be at least partially transparent or to ensure transmissibility. Suitable pigment particle diameters, degrees of filling, dimensions of the luminous elements and interspacings of the luminous elements have been mentioned hereinbefore.

The layer contains the aforementioned, optionally doped ZnS crystals, preferably microencapsulated as described above, preferably in an amount of 40 to 90 wt. %, more preferably 50 to 80 wt. %, particularly preferably 55 to 70 wt. %, in each case referred to the weight of the paste. One-component and preferably two-component polyurethanes can be used as binder. Preferred according to the invention are highly flexible materials from Bayer MaterialScience AG, for example the lacquer raw materials of the Desmophen and Desmodur ranges, preferably Desmophen and Desmodur, or the lacquer raw materials of the Lupranate, Lupranol, Pluracol or Lupraphen ranges from BASF AG. As solvents, ethoxypropyl acetate, ethyl acetate, butyl acetate, methoxypropyl acetate, acetone, methyl ethyl ketone, methyl isobutyl ketone, cyclohexanone, toluene, xylene, solvent naphtha 100 or arbitrary mixtures of two or more of these solvents can be used in amounts of preferably 1 to 50 wt. %, preferably 2 to 30 wt. %, particularly preferably 5 to 15 wt. %, in each case referred to the total amount of paste. Furthermore other highly flexible binders, for example those based on PMMA, PVA, in particular mowiol and poval from Kuraray Europe GmbH (now called Kuraray Specialties) or polyviol from Wacker AG, or PVB, in particular mowital from Kuraray Europe GmbH (B 20H, B 30 T, B 30H, B 30 HH, B 45H, B 60 T, B 60H, B 60 HH, B 75H), or pioloform, in particular pioloform BR18, BM18 or BT18, from Wacker AG, can be used. When using polymeric binders such as for example PVB, solvents such as methanol, ethanol, propanol, isopropanol, diacetone alcohol, benzyl alcohol, 1-methoxypropanol-2, butyl glycol, methoxybutanol, dowanol, methoxypropyl acetate, methyl acetate, ethyl acetate, butyl acetate, butoxyl, glycolic acid n-butyl ester, acetone, methyl ethyl ketone, methyl isobutyl ketone, cyclohexanone, toluene, xylene, hexane, cyclohexane, heptane as well as mixtures of two or more of the aforementioned solvents can furthermore be added in amounts of 1 to 30 wt. % referred to the total weight of the paste, preferably 2 to 20 wt. %, particularly preferably 3 to 10 wt. %.

In addition 0.1 to 2 wt. % of additives can be included in order to improve the flow behaviour and the flow. Examples of flow improvers are Additol XL480 in butoxyl in a mixing ratio of 40:60 to 60:40. As further additives 0.01 to 10 wt. %, preferably 0.05 to 5 wt. %, particularly preferably 0.1 to 2 wt. %, in each case referred to the total weight of the paste, of rheology additives can be included, which reduce the settling behaviour of pigments and fillers in the paste, for example BYK 410, BYK 411, BYK 430, BYK 431 or arbitrary mixtures thereof.

Particularly preferred formulations according to the invention of printing pastes for the production of the EL luminous pigment layer as component BC contain:

| | Content/ | Content/ | Content/ | Content/ |
|---|---|---|---|---|
| Substance | wt. % | wt. % | wt. % | wt. % |
| Pigment | 55.3 | 69.7 | 64.75 | 65.1 |
| (Osram Sylvania) | | | | |
| Desmophen D670 | 18.5 | 11.9 | 12.7 | 13.1 |
| (BMS) | | | | |
| Desmodur N75 MPA | 16.0 | 9.0 | 12.4 | 11.3 |
| (BMS) | | | | |
| Ethoxypropyl acetate | 9.8 | 9.1 | 9.9 | 10.2 |
| Additol XL480 | 0.4 | 0.3 | 0.25 | 0.3 |
| (50 wt. % in butoxyl) | | | | |

| | Content/ | Content/ | Content/ |
|---|---|---|---|
| Substance | wt. % | wt. % | wt. % |
| Pigment (Osram Sylvania) | 61.2 | 65.1 | 69.7 |
| Desmophen D670 (BMS) | 15.2 | 12.7 | 11.9 |
| Desmodur N75 MPA (BMS) | 13.1 | 11.4 | 9.0 |
| Methoxypropyl acetate | 10.2 | 5.5 | 4.9 |
| Ethoxypropyl acetate | 0 | 5 | 4.2 |
| Additol XL480 (50 wt. % in butoxyl) | 0.3 | 0.3 | 0.3 |

| | Content/ | Content/ |
|---|---|---|
| Substance | wt. % | wt. % |
| Pigment (Osram Sylvania) | 61.2 | 69.7 |
| Desmophen 1800 (BMS) | 17.7 | 14.1 |
| Desmodur L67 MPA/X (BMS) | 9.9 | 7.9 |
| Ethoxypropyl acetate | 10.8 | 8.0 |
| Additol XL480 (50 wt. % in butoxyl) | 0.4 | 0.3 |

### Cover Layer

In addition to the components A and B the EL element according to the invention contains a protective layer, component CA, in order to prevent a destruction of the electroluminescent element or of the possibly present graphical representations. Suitable materials for the protective layer are known to the person skilled in the art. Suitable protective layers CA are for example high temperature resistant protective lacquers such as protective lacquers containing polycarbonates and binder. An example of such a protective lacquer is Noriphan® HTR from Pröll, Welβenburg.

Alternatively the protective layer can also be formulated on the basis of flexible polymers such as polyurethanes, PMMA, PVA or PVB. Polyurethanes from Bayer MaterialScience AG can be used for this purpose. This formulation can also be provided with fillers. All fillers known to the person skilled in the art are suitable for this purpose, for example based on inorganic metal oxides such as TiO₂, ZnO, lithopones, etc., with a degree of filling of 10 to 80 wt. % of the printing paste, preferably a degree of filling of 20 to 70%, particularly preferably of 40 to 60%. Furthermore the formulations can contain flow improvers as well as rheology additives. As solvents there can be used for example ethoxypropyl acetate, ethyl acetate, butyl acetate, methoxypropyl acetate, acetone, methyl ethyl ketone, methyl isobutyl ketone, cyclohexanone, toluene, xylene, solvent naphtha 100 or mixtures of two or more of these solvents.

According to the invention particularly preferred formulations of the protective lacquer CA contain for example:

| | Content/ | Content/ | Content/ | Content/ |
|---|---|---|---|---|
| Substance | wt. % | wt. % | wt. % | wt. % |
| Desmophen 670 (BMS) | 18.9 | 22.0 | 17.3 | 22.0 |
| Additol XL480 | 1.2 | 0.8 | 1.0 | 0.8 |
| (50 wt. % in butoxyl) | | | | |
| Desmodur N75 MPA | 20.0 | 20.0 | 17.4 | 20.0 |
| (BMS) | | | | |
| Ethoxypropyl acetate | 4.5 | 8.5 | 4.3 | 0 |
| Methoxypropyl acetate | 0 | 0 | 0 | 8.5 |
| TiO₂ | 55.4 | 48.7 | 60.0 | 48.7 |

| | Content/ |
|---|---|
| Substance | wt. % |
| Desmophen 1800 (BMS) | 22.9 |
| Additol XL480 (50 wt. % in butoxyl) | 1.1 |
| Desmodur L67 MPA/X (BMS) | 12.9 |
| Ethoxypropyl acetate | 10.6 |
| TiO₂ | 52.5 |

### Substrates

The EL element according to the invention can comprise on one or both sides of the respective electrodes, substrates such as for example glasses, plastics films or the like.

In the EL element according to the invention it is preferred if at least the substrate that is in contact with the transparent electrode is designed in a graphically glazingly translucent and opaquely covering manner on the inside. An opaque covering design is understood to mean a large area electroluminescence region that is opaquely covered by a high-resolution graphical design and/or is formed glazingly, for example in the sense of red-green-blue, translucently for signalling purposes.

In addition it is preferred if the substrate that is in contact with the transparent electrode BA is a film that is cold-stretch formable below the glass transition temperature Tg. In this way the possibility is provided of shaping the resulting EL element three-dimensionally.

Furthermore it is preferred if the substrate that is in contact with the rear electrode BE is a film that is likewise cold-stretch formable below Tg. In this way the possibility is provided of shaping the resulting EL element three-dimensionally.

The EL element is thus three-dimensionally formable, wherein the radii of curvature may be less than 2 mm, preferably less than 1 mm. The deformation angle can in this connection be greater than 60°, preferably greater than 75°, particularly preferably greater than 90° and especially greater than 105°.

Moreover it is preferred if the EL element is three-dimensionally formable and in particular is cold-stretch formable below Tg and in this way receives a precise shaped three-dimensional design.

The three-dimensionally shaped element can be formed on at least one side with a thermoplastic material in an injection mould.

### Production of EL Elements According to the Invention

Normally the pastes mentioned hereinbefore (screen printing pastes) are applied to transparent plastics films or glasses, which in turn comprise a largely transparent electrically conducting layer and thereby form the electrode for the visual display side. The dielectric material, if present, and the rear side electrode are then produced by printing techniques and/or lamination techniques.

A reverse production process is however also possible, in which first of all the rear side electrode is produced or the rear side electrode is used in the form of a metallised film and the dielectric material is applied to this electrode. The EL layer and following this the transparent and electrically conducting upper electrode are then applied. The resultant system can then optionally be laminated with a transparent cover film and thereby protected against water vapour and also against mechanical damage.

In one embodiment of the invention the conducting tracks (silver bus) can be applied as first layer to the substrate A. According to the invention they are however preferably applied to the electrodes BA and BE either in two work stages, in each case individually to the electrodes, or jointly in one work step to the electrodes.

The EL layer is normally applied by a printing technique by means of screen printing or dispenser application or ink-jet application, or also in a knife coating procedure or a roller coating method or a curtain casting method or a transfer method, but preferably by means of screen printing. The EL layer is preferably applied to the surface of the electrode or to the insulating layer optionally applied to the rear electrode.

The present invention also provides for the use of an electroluminescent element as described above as a decorative element and/or luminous element in interiors or for external use, preferably on external facades of buildings, in or on facilities and installations, in or on land, airborne or waterborne vehicles, in or on electrical or electronic devices, or in the advertising sector.

In this connection the electroluminescent element can be designed as an optically signalling element, in which the voltage levels, the voltage differences, the frequencies and/or the frequency differences can be controlled and modulated by the loudness level and the frequency response of a music source and/or by electronic, sensory and/or computer-controlled regulation. Also, the electroluminescent element according to the invention can be designed as a combined safety glass element or as an insulating glass element.

The electroluminescent element can thus be used as a visual indicator for measurable and/or sensorially detectable quantities, in particular noise, smoke, vibration, speed, atmospheric humidity and/or temperature.

Some examples of implementation of the invention are described in more detail hereinafter with the aid of the drawings, in which:

FIG. 1: is a diagrammatic plan view of the EL element (1) with two flat electrodes (4, 5) and four electrical connections (15 to 18).

FIG. 2: is a section A-B through the EL element (1) illustrated by way of example in FIG. 1,

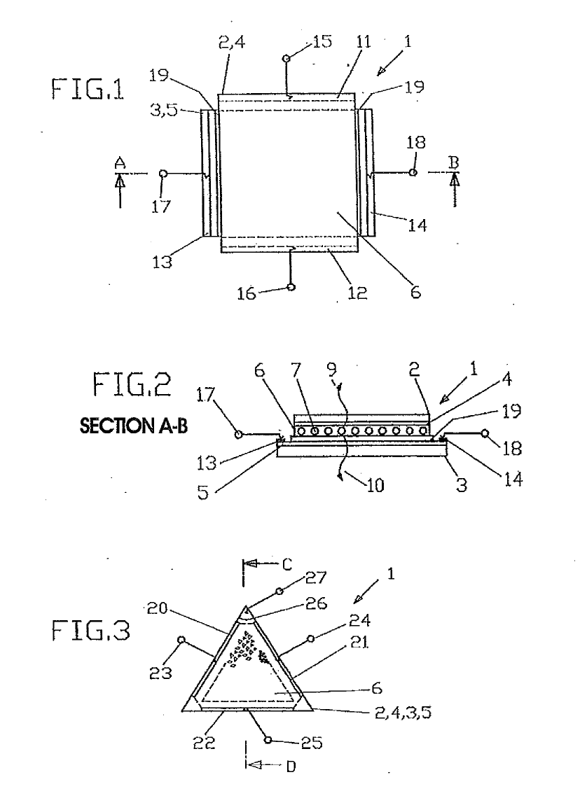

FIG. 3: is a diagrammatic plan view of a triangularly shaped EL element (1) with three electrical connections (23, 24, 25) on the upper electrode (4) and a connection (27) on the lower electrode (5),

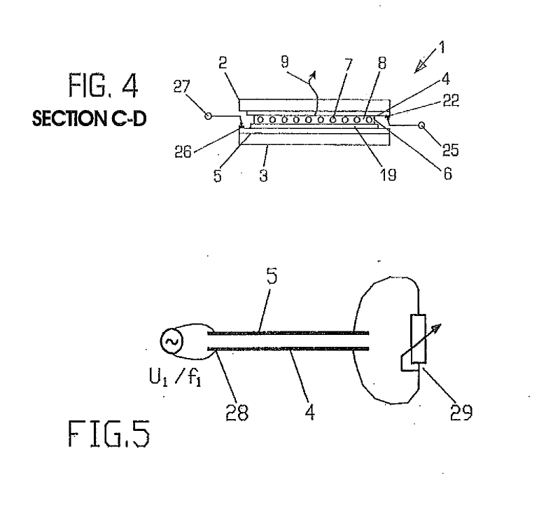

FIG. 4: is a section A-B through the triangularly shaped EL element (1) illustrated by way of example in FIG. 3,

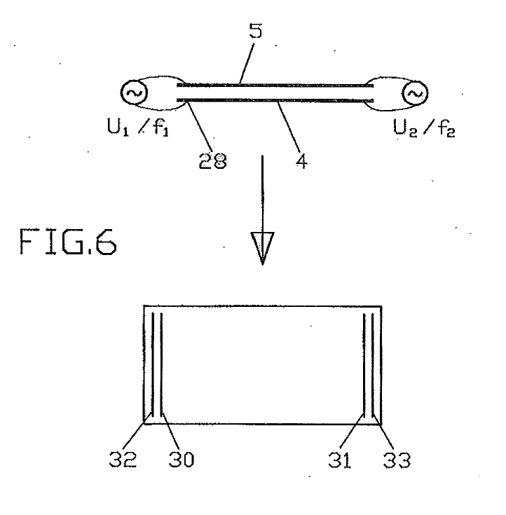

FIG. 5: is a diagrammatic side view of an EL element with two flat electrodes (4, 5) and a connection (28) and a connection (29),

FIG. 6: is a diagrammatic side view (first figure) and plan view (second figure) of an EL element with two flat electrodes (4, 5) and two connections (28).

FIG. 1 shows a diagrammatic plan view of an EL element (1) with two flat electrodes (4, 5), and four electrical connections (15 to 18).

In this implementation variant the upper flat electrode (4) and the lower flat electrode (5) are chosen having such a sheet resistance that busbars (11 to 14) can be arranged on both marginated edges and can be provided with electrical contacts (15 to 18), and different voltages and frequencies can be applied corresponding to the selected sheet resistance of the electrodes (4, 5) and the dimensions.

Both electrodes (4, 5) are designed so as to be transparent. If an electrically highly conducting, non-transparent electrode is chosen, then this electrode cannot be supplied with a different voltage on two opposite edges since a relatively high current would flow and would thereby damage the electrode, or the voltage supply would break down.

The substrates (2, 3) are shown by way of example and for simplicity of illustration to be overlapping, and depending on the case are also chosen having the same dimensions. In addition it is also possible for one substrate to be larger than the other substrate. In principle one of the two substrates (2,3) can also be omitted. The respective electrodes (4, 5) can be positioned exactly for example by printing techniques, or can be applied by a roller coating method, a curtain casting method or a spray method. Thermoplastic films are then often also arranged thereabove using lamination technology methods.

In the plan view shown in FIG. 1 the electroluminescent field (6) is formed over the whole surface. It can however be implemented in virtually any desired design, for example in the manner of a window or screen or graphically designed, e.g. In a punctiform manner or in the form of individual elements.

The electroluminescent field (6) can be arranged in the region of the covering electrodes (4, 5), in which connection the electroluminescent field can already have an electrical insulation property. It is however also possible that the electrical Insulation property is not sufficient. In this case insulating layers, for example two insulating layers (19), are usually provided.

If now an alternating voltage is applied to the left-hand connection (17) that is a few volts to a few tens of volts less than the alternating voltage applied to the right-hand connection (18), then the electroluminescent field (6) at the right-hand edge produces a bright visible EL emission (9, 10). If in addition an alternating voltage is applied to the lower connection (16) that is a few volts to a few tens of volts less than the alternating voltage applied to the upper connection (15), then the EL field (6) at the upper edge produces a brighter visible EL emission (9, 10). In the combination of an alternating voltage (15, 16, 17, 18) applied in this way the top right-hand corner of the EL field (6) will shine most brightly and the bottom left-hand corner will shine least brightly.

If the four voltages (15, 16, 17, 18) are regulated differently timewise as regards their voltage level, then it is understandable that a two-dimensional dynamic brightness field can be generated in this way. In addition the flat EL field (6) can be designed with different emission colours and in this way colour effects can also be generated.

If in addition to the electrical connections (15, 16) and (17, 18) different frequencies are input, then so-called beats are produced.

FIG. 2 shows a section A-B through the EL element (1) illustrated by way of example in FIG. 1. In this section A-B the lower substrate (3) is illustrated together with the lower flat electrode (5) and the two busbars (13, 14) and the electrical connections (17, 18). The busbars (13, 14) are low resistance strip-shaped contact elements, which in the case of a polymeric substrate (3) are normally realised in the form of a screen printing strip with electrically highly conducting pastes or paste combinations. Silver pastes, copper pastes, carbon pastes or often a silver paste with a carbon paste overprint are conventional busbar systems. If a glass substrate (3) is used, then stovable and solderable silver-based and/or aluminium-based pastes can be employed.

The insulating layer (19), then the EL layer (6) and following this the upper electrode (4) together with the substrate (2) are then arranged on the electrode (5). The order of the layers (19, 6) can also be reversed. It should however be ensured that in this case the insulating layer (19) is designed to be largely transparent. Often the insulating layer (19) is applied by screen printing techniques. Since in screen printing small air inclusions cannot be avoided, the layer (19) is often formed as a double layer. In the exemplary case of the up (9) and down (10) EL emission the insulating layer (19) should be as transparent as possible.

The EL layer (6) comprises EL pigments (7) and a binder matrix (8). If polymeric substrates (2, 3) are used, microencapsulated zinc sulfide electroluminophore pigments (7) are normally employed. Half-life times of up to more than 2,000 hours can be achieved in this way. The half-life time of an EL element (1) is understood to be the operating time for the brightness to fall to half the initial value.

If glass substrates (2, 3) are used, unencapsulated zinc sulfide electroluminophore pigments (7) can also be employed, since the glass substrates (2, 3) normally form an excellent barrier to water vapour and in this way the water vapour load of the EL pigments (7) is prevented or reduced to a minimum.

FIG. 3 is a diagrammatic plan view of a triangular EL element (1) with three electrical connections (23, 24, 25) on the three busbars (20, 21, 22) on the upper electrode (4) and a connection (27) on the lower electrode (5). Here the voltage values and the frequencies at the three connections (23, 24, 25) can be varied compared to the base electrode connection (27), and two-dimensional brightness and colour patterns in the EL field (6) can be generated with the in this case unilateral EL emission (9). Since the rear side electrode (5) was chosen as a low resistance, opaque electrode, a relatively small busbar (27) can be chosen for the electrical connection (27).

The EL field (6) can be configured in different ways. In this connection a full area EL layer (6) with only one emission colour or a running colour per corner can be formed, and grid-like points or geometrical signs and symbols or artistically designed elements of different sizes and different interspacing can be arranged. The punctiform or element-like arrangement can in this connection be arranged uniformly or randomly and the elements can be arranged so as to run into one another.

FIG. 4 shows a section A-B through the triangular EL element (1) illustrated by way of example in FIG. 3. In this diagrammatic section both substrates (2, 3) are formed equally large. In principle the substrates (2, 3) can however have virtually any desired formats and shapes. Moreover, the electrical busbar contacts can be formed on side edge lines or point contacts on edges or virtually on any desired internal electrode surfaces. In all cases care should be taken to ensure an efficient, cost-effective and long-life contacting of the electrodes (4, 5).

FIG. 5 shows a variant of the electroluminescent element according to the invention, in which an upper flat electrode (4) and a lower flat electrode (5) are provided. Both electrodes are connected to a voltage source (28), a voltage difference being produced by means of a potentiometer.

In FIG. 6 two voltage sources (28) are provided, wherein the busbars on the upper flat electrode (4) and on the lower flat electrode (5) are in each case arranged parallel and above one another (30, 31, 32 and 33).

### LIST OF REFERENCE NUMERALS

1 Electroluminescent (EL) element based on a particular zinc sulfide thick-film with at least two alternating voltage feeders on two spaced-apart marginated points
2 Upper substrate
3 Lower substrate
4 Upper flat electrode
5 Lower flat electrode
6 EL layer or EL region
7 EL pigment
8 EL binder matrix
9 Up EL emission
10 Down EL emission
11 Upper busbar (on the upper electrode)
12 Lower busbar (on the upper electrode)
12 Left-hand busbar (on the lower electrode)
14 Right-hand busbar (on the lower electrode)
15 Upper electrical connection
16 Lower electrical connection
17 Left-hand electrical connection
18 Right-hand electrical connection
19 Insulating layer: single layer or double layer; transparent or opaque
20 Busbar 1
21 Busbar 2
22 Busbar 3
23 Electrical connection to busbar 1
24 Electrical connection to busbar 2
25 Electrical connection to busbar 3
26 Electrical connection region, lower electrode; contact surface
27 Electrical connection, lower electrode
28 Voltage source
29 Potentiometer
30 Busbar; front electrode connection 1
31 Busbar; front electrode connection 2
32 Busbar; rear electrode connection 1
33 Busbar; rear electrode connection 2

1.-15. (canceled)

16. An electroluminescent element comprising a zinc sulfide thick film with at least two planar electrodes, wherein at least one of the electrodes is transparent, and wherein on at least one of the electrodes at least two alternating voltage feeders are provided at two sites spaced apart from one another.

17. The electroluminescent element according to claim 16, wherein a voltage difference and/or the frequency difference between the at least two alternating voltage feeders is altered by electronic, sensory and/or computer-controlled regulation.

18. The electroluminescent element according to claim 16, wherein the alternating voltage feeders comprise busbars which include connection contacts for the alternating voltage feeders.

19. The electroluminescent element according to claim 18, wherein the busbar produces a uniform electroluminescence emission over the whole electroluminescent surface.

20. The electroluminescent element according to claim 16, wherein the electroluminescent element is arranged on a plastics film or a glass substrate.

21. The electroluminescent element according to claim 16, wherein the electroluminescent element is arranged between two laminated planar elements.

22. The electroluminescent element according to claim 16, wherein the electroluminescent element is rectangular, strip-shaped, round, polygonal and/or is provided with an artistically designed shape or configuration.

23. The electroluminescent element according to claim 16, wherein the electroluminescent element is translucent and an EL emission takes place on both sides.

24. The electroluminescent element according to claim 16, wherein the electroluminescent element is three-dimensionally shaped.

25. The electroluminescent element according to claim 24, wherein the three-dimensionally shaped electroluminescent element is formed in an interlocking manner with a thermoplastic material in an injection mould.

26. The electroluminescent element according to claim 16, wherein the electroluminescent element is formed as a combined safety glass element or as an insulating glass element.

27. A use of the electroluminescent element according to claim 16 as a decorative element and/or luminous element in interiors or for external use, preferably on external facades of buildings, in or on facilities and installations, in or on land, airborne or waterborne vehicles, in or on electrical or electronic equipment, or in the advertising sector.

28. A use of the electroluminescent element according to claim 16, wherein the electroluminescent element is an optically signalling element, wherein a voltage level, a voltage difference, a frequency and/or a frequency difference is controlled and modulated by a sound intensity and a frequency response of a music source.

29. A use of the electroluminescent element according to claim 16, wherein the electroluminescent element is used as a visual indicator for measurable and/or sensorially detectable quantities, in particular noise, smoke, vibration, velocity, atmospheric humidity and/or temperature.

30. A process for the production of an electroluminescent element based on a zinc sulfide thick film, the process comprising:
producing the zinc sulfide thick film having at least two planar electrodes, wherein at least one of the planar electrodes is transparent; and
connecting at least two alternating voltage feeders to two sites arranged spaced apart from one another on at least one of the planar electrodes.
